(19) United States
(12) Patent Application Publication
(10) Pub. No.: US 2003/0172314 A1
(43) Pub. Date: Sep. 11, 2003

(54) Timer monitoring apparatus and method

(76) Inventor: Greene E. Walter, Mansfield, MA (US)

Correspondence Address: MOTOROLA, INC., 1303 EAST ALGONQUIN ROAD, IL01/3RD, SCHAUMBURG, IL, 60196

(21) Appl. No.: 10/093,864

(22) Filed: Mar. 8, 2002

(51) Int. Cl. G06F 1/14

(52) U.S. Cl. 713/502

(57) ABSTRACT

There is disclosed a process for monitoring a plurality of software timers, each having a predetermined time-out value. Each timer is assigned to one of a plurality of timer bins, wherein each timer bin has an assigned maximum and a minimum value defining the bin time range, such that the plurality of timer bin ranges contiguously subdivide the interval from zero seconds to the maximum time-out value of the plurality of timers. Each timer is assigned to that timer bin having a bin time range including the time-out value. Since a timer cannot time out before its time-out value, each timer within a timer bin is checked no less frequently than the lower time range value for the bin. As a timer approaches its time-out value, the timer is moved to lower level bins such that the time-out value is always within the timer bin range. For those timers that are reset, they are moved to a higher timer bin, again such that the time-out value falls within the timer bin range. Timers time out only from the lowest bin.

### FIELD OF THE INVENTION

The present invention relates generally to a method and apparatus for monitoring a timer embedded within a software program and, in particular, to a method and apparatus for determining when each one of a plurality of such timers has timed out.

### BACKGROUND OF THE INVENTION

The present invention is applicable to a software-controlled microprocessor or microcontroller-based systems, wherein the software includes one or more event timers (also referred to as counters) to control operation of an object between two temporal boundaries defined by the timer start time (or initial value) and stop time (when the interval defined by the initial value has elapsed), with a reset of the timer upon the occurrence of a predetermined resetting event. As applied to software-driven processes, an object exists or is in use only so long as there is ongoing activity associated with the object. When the activity ceases, the object can be freed, allowing its resources to be used by other software objects. To detect inactivity and thus the opportunity to reassign the object, a timer measures the elapsed time since the last activity associated with the object. When this period of inactivity reaches a predetermined value, the timer times out and the object resource can be reassigned. For example, reserved memory is an object that can be freed when the timer associated with the reserved memory times-out. Each time the reserved memory is accessed, the timer is reset to its initial value, thus increasing the interval until the reserved memory will be freed.

Following is a detailed description of timer operation. The occurrence of a predetermined event sets a timer associated with the object to a first predetermined value (i.e., the start time or start count), followed by decrementation at a predetermined rate. In a microprocessor-based system, the decrement rate is typically a clock cycle or a multiple thereof. When the timer reaches a second predetermined value (i.e., the stop or time-out time), a response action is triggered. During the decrementation period, the timer may be reset to its start time by the occurrence of a specific event. Many such timers may be employed in the operation of a microprocessor or microcontroller, with each timer associated with a unique event and having a different start time and time-out time. It is also possible to employ different decrementation rates for the timers. Further, since each timer is associated with a different operational element of the system, each is reset to its start time based on the occurrence of a different event. Typically, the time-out time is zero although this is not necessarily required. It is well known in the art that similar functionality can be provided by an incrementing timer, instead of a decrementing timer. In either case, the start time, time-out time and decrement rate define the timer operation.

Personal computers use a plurality of such event timers, for example, for controlling communications with peripheral devices connected to the computer microprocessor via a peripheral bus. To control a device on the peripheral bus, the microprocessor sends commands or requests to the target peripheral device and concurrently sets an event timer associated with the command or request. The timer essentially sets an upper boundary for the response time from the peripheral device. While waiting for a response from one peripheral device, the processor can send commands to other peripheral devices or additional commands to the same peripheral device. Accordingly, the processor may be waiting for responses from several pending commands, each controlled by a designated timer. Each command has a different start time and likely a different time-out period. When the peripheral responds the timer is reset or may be abandoned as it is no longer necessary to measure the peripheral response time. If the peripheral device does not respond before the time-out period is reached, an error has presumably occurred and the processor must handle the error according to the command or request that was sent. Typically, in these embodiments the decrement time is a clock cycle of the microprocessor and the time-out time is zero.

According to conventional processing, each pending command requires a separate timer. With protocols for peripheral devices now permitting greater numbers of pending data transfers and given the broad spectrum of peripheral devices that are controlled, a large number of commands can be pending and several time-out periods must therefore be simultaneously monitored. Providing timers for each pending command with various time-out values associated with each timer, increases microprocessor complexity and cost and expends valuable processing resources.

Another system employing a plurality of timers is the two-way cable network communication system, as illustrated in block diagram form in FIG. 1. The prior art cable system includes head-end equipment 101, a hybrid fiber/coaxial cable plant 103, a plurality of cable modems 105 and 106 and a corresponding plurality of subscriber communications devices 107 and 108, which are coupled to the cable modems 105 and 106 via corresponding communications link 116 and 117, respectively. The subscriber communications device 107 and 108 include, for example, a computer, a television or a telephone. As is well known to those skilled in the art, the head-end equipment 101 includes processors, routers, switches, a broadband downstream transmitter, upstream receivers, splitters, combiners, subscriber data bases, network management stations, servers, and media gateways. The hybrid fiber/coaxial cable plant 103 includes fiber optic cables, coaxial cables, nodes, amplifiers, filters, and taps that support transmission from the head-end equipment 101 to the cable modems 105 and 106 over a shared downstream channel 110, and transmissions from the cable modem 105 and 106 to the head-end equipment 101 over a shared upstream channel 112. Television programs signals are input to the head-end equipment 101 for broadcast to the subscribers via the hybrid fiber/coaxial cable plant 103.

The head-end equipment 101 is typically coupled via an appropriate communications link 119, such as a fiber distributed data interface (FDDI) link or a 100-base T Ethernet link, to an external network 114, such as the public switch to telephone network or a wide area packetized network, such as the Internet. Thus the two-way cable system provides communications connectivity between the subscriber communications devices 107 and 108 and other similar devices (not shown in FIG. 1) and Internet servers, computer networks and so forth as represented by the external network 114.

Generally, 64-ary or 256-ary quadrature amplitude modulation (QAM) is employed to convey information over the downstream channel 110, which is capable of delivering up to 30 to 40 Mbps of data on a 6 MHz cable television channel. The upstream channel 112 uses either QPSK or 16 QAM signaling with data rates available from 320 Kbps to 10 Mbps. Both the upstream and downstream data rates are configurable by the system operator. For instance, the cable modem 105 utilized by a business user can be configured to receive and transmit information at relatively high data rates in both directions. A residential user's cable modem 105 can be configured with wider bandwidth (and therefore a higher data rate) in the downstream direction for receiving data from the external network 114, while limited to a lower speed for upstream data transmission, since a residential user typically requires the conveyance of more data in the upstream direction (for example, Web pages) than in the downstream direction (a Web text-based search). In yet another embodiment, data rate assignments can be time-of-day sensitive.

A packet switched network, such as the cable system network illustrated in FIG. 1, typically operates on a best-efforts service delivery basis. Unfortunately, the Internet protocol, employing a connection-less best efforts delivery model, does not guarantee delivery of packets in order, in a timely manner or at all. All traffic has an equal priority and therefore an equal chance of reaching its destination in a timely manner. When the network is congested, all traffic also has an equal chance of being delayed or dropped. Among the many types of applications using the network are mission-critical applications interfacing with the Worldwide Web, on-line business critical applications, multimedia applications (such as desktop video conferencing and Web based training) and voice-over-internet protocol telephone calls. Certain network applications may be bandwidth and delay sensitive. Some applications require real-time delivery to the receiving site, while other applications can tolerate some delay. To deploy real-time applications on the Internet, such as voice-over-IP or video conferencing, an acceptable level of service quality, including bandwidth, latency and jitter, must be guaranteed and further must be met in a fashion that allows the real-time high priority traffic to co-exist with traditional data traffic on the network, with each type of traffic reaching its destination within a reasonable time.

Employing a class of service or quality of service concept allows the network operator to ensure that mission critical and real time applications traffic is protected from other bandwidth-hungry applications, while enabling less critical applications to utilize the network in a reasonably efficient fashion. To achieve this objective, network quality of service policies align network resources with the network user's objective. Without these service classifications, network resources could become quickly exhausted by non-vital applications, at the expense of more important ones. Implementation of class of service features allows network devices to recognize and deliver high-priority traffic in a predicable manner. When network congestion occurs, the class of service mechanism drops or delays low-priority traffic to allow delivery of high-priority traffic.

To implement these quality of service features, the DOCSIS 1.0 and 1.1 standard protocols allow configuration of a cable modem, such as the cable modems 105 and 106 with multiple service flows or data flows for carrying data in the upstream direction. Under the DOCSIS 1.0 standard, the network operator can activate a configuration setting to instruct the cable modem to send certain data types on specific service flows. For example, the cable modem may be configured to place all voice packets on service flow two while all other data packets are transmitted over the primary service flow, i.e., service flow one.

The DOCSIS 1.1 specification further establishes a parameter representing the length of time during which an active service flow can remain inactive before it times out. Active service flows time out when there has been no activity (i.e., sending or receiving data) on the flow for a predetermined period. When the flow times out, the resources allocated to it can be used by other service flows. There may be 8,000 to 10,000 simultaneously active flows in a cable system, each with a different and constantly decremented time period before the flow times out. Clearly it is inefficient to allocate one timer to each service flow although this is the current practice. Further adding to the inefficiency, there may be a significant amount of data transfer on a service flow, which requires regular and frequent resetting of the service flow timer. At every clock tick, each timer must be decremented and checked to see if it has reached zero. According to the prior art, this determination is made even when the timer is thousands of clock ticks away from timing out.

A prior art technique applicable to constant delay timers, i.e., timers for objects (e.g., service flows) that are always reset to the same time value when a resetting event occurs, involves assembling the objects into a sorted list in descending order. That is, the object at the head of the list is the next one to time out. The list entry for each object also includes the amount of time until time out occurs for the next object in the list. With this method, only the first object must be checked for a time out at each clock tick. This process could be adapted for non-constant time out lengths, but this requires sorting the list after each timer reset event, and would therefore be computationally intensive when there is considerable activity (and therefore frequent timer resets) for the various objects. The process would require locating and pulling each object from the list whenever a reset activity occurs for that object, recalculating the remaining time until the timer times out and placing the timer back in the list at the proper position.

### BRIEF DESCRIPTION OF THE DRAWINGS

The present invention can be more easily understood and the further advantages and uses thereof more readily apparent, when considered in view of the description of the preferred embodiments and the following figures in which:

FIG. 1 is a block diagram of a typical prior art two-way cable communication system;

FIG. 2 illustrates a plurality of timer bins in accordance with the teachings of the present invention; and

FIG. 3 is a flowchart depicting the process of the present invention.

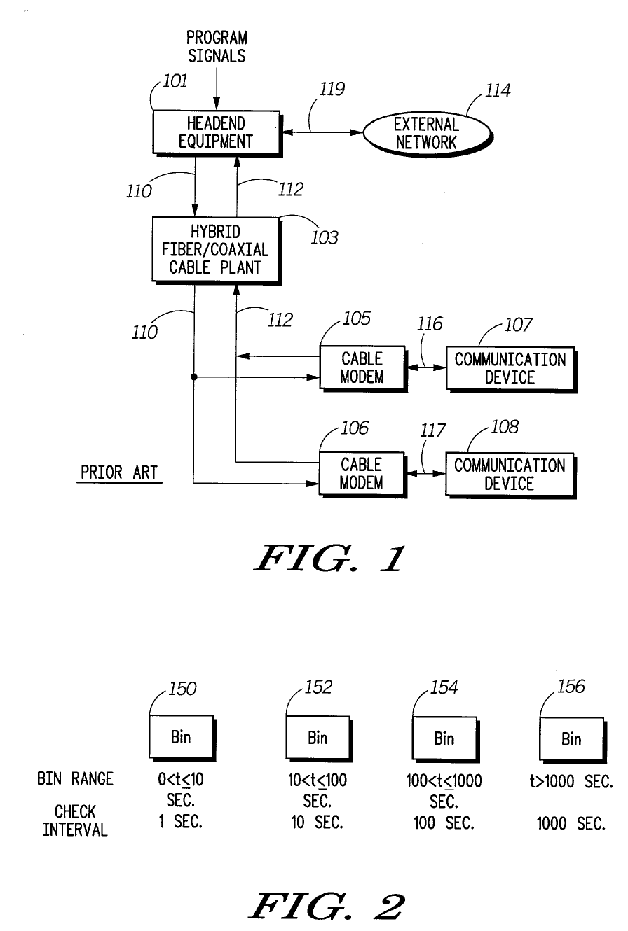

### DETAILED DESCRIPTION OF THE INVENTION

Before describing in detail the particular method and apparatus for monitoring multiple timers, it should be observed that the present invention resides primarily in a novel combination of steps and apparatus related thereto. Accordingly, the hardware components and method steps have been represented by conventional elements in the drawings, showing only those specific details that are pertinent to the present invention, so as not to obscure the disclosure with structural details that will be readily apparent to those skilled in the art having the benefit of the description herein.

Use of the timer control mechanisms associated with the present invention reduces the computational overhead associated with managing a plurality of timers, many of which are reset on a frequent basis. The number of checks performed on each timer to determine whether the timer has timed out is always less or equal to the number required when each timer is individually monitored, as taught by the prior art.

Conventional timer monitoring suggests that if a timer is incremented on a one second basis it must be checked every second to detect whether the time out has occurred. According to the present invention, checking the timer count at every decrement interval is not always required. If it is known that a timer cannot time out within a certain time interval, then there is no need to check the time during that interval. For example, when a timer is activated with a time out value of 1500 seconds, it is impossible for the timer to time out before 1500 seconds, and in fact the timer may be reset during the 1500 seconds interval. As a result, it is not necessary to check the timer to determine if it has timed out during the 1500 second interval.

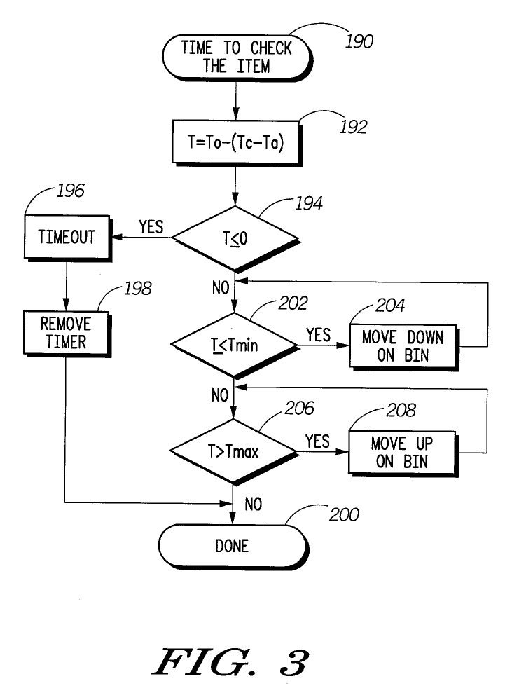

According to the present invention, a series of software structures, referred to as timer bins 150, 152, 154 and 156 are created to representationally store timers. See FIG. 2. Each bin 150, 152, 154 and 156 has an assigned time range and all timers stored within the bin must have a time out value within that range. For example, the bin 152 stores timers with a time out value between 10 and 100 seconds. The bin 156 stores timers having a time out value greater than 1000 seconds. The choice of the time intervals for each bin 150, 152, 154 and 156 is based on the time-out values of the timers to be stored. The more bins created, the more computationally efficient the timer monitoring mechanism. In the FIG. 2 embodiment, the timers are decremented every second. The number of bins, the time range of each bin and the decrement rate are user configured values based on the application in which the invention is employed. FIG. 2 also illustrates the time interval at which each bin must be checked. For example, the bin 150 is checked once per second and the bin 154 is checked every 100 seconds. The check interval for each bin is determined by the time range for the stored timers. The check interval for the bin 150, the bin requiring the most frequent checking, is determined by the decrement rate and the desired granularity for the determining whether a timer has timed out. For example, if the timers stored within the bin 150 are decremented at two second intervals, then the bin 150 can be checked at two second intervals. Note that with the exception of the bin 150, each of the bins 152, 154 and 156 has a check interval equal to the lower range limit, because all of the timers within the bin cannot time out sooner than that lower range value.

When each timer in a bin is checked, i.e., the current timer value is compared with the timer time-out value, there are four possible outcomes. If the timer resides in the bin 150, then it may have timed out and will therefore be removed from the bin 150. Note that timers can be removed from the process only from the bin 150; timed out timers stored in bins with higher ranges are dropped to the next lower range when the timer value has dropped below the minimum value of the bin. Then the object associated with a timed-out timer is available for reassignment. As a second possible outcome, a timer may time out in a time period less than the range of its current bin, and therefore the timer is moved to the appropriate lower bin. The third possible outcome is the timer time-out period is still within the time range of its present bin and therefore the timer remains within its current bin. Finally, recall that timers are reset based on the occurrence of an event involving the object with which the timer is associated. For example, the transfer of data on the service flow associated with the timer of interest causes the timer to be reset to its initial value. This resetting process occurs independently of the bin in which the timer is stored and independently of the timer check process. Therefore, if a timer has been reset and the new time out value is greater than the range of the current bin, then the timer is moved upwardly to the appropriate bin.

In one embodiment, a reset of a timer is marked by the current time when the reset action occurs, rather than returning the timer count to zero. Therefore, to determine the length of time until time-out, the time remaining on the timer must first be determined. This is calculated by taking the unsigned difference between the present time and the time of the last reset or the last activity. Typically, the present or current time value will be greater than the time of the last activity. In one embodiment, this calculation is performed using 16-bit binary representations of the time values, such that 65536 timer or clock ticks can be counted (2¹⁶=65536). Several examples are presented, wherein Tₐ is the time of the last reset action or the last activity associated with the timer and T_{c} is the current time.

If the last reset occurred at clock tick 102 and the current time is at clock tick 1355, then T_{c}−Tₐ=1355−102=1253 clock ticks have occurred since the last reset. This value is subtracted from the timer's time-out value to yield the length of time until a time out occurs, assuming no further reset actions. If the time interval until the next time-out is below the range of the current bin, the timer is moved to the appropriate lower bin. If there had been activity associated with this timer since the last timer check, the timer will have been reset by this activity and the interval until the next time-out can now be greater than the maximum time range of the current bin. The timer is therefore moved up to the appropriate higher bin.

Assume that Tₐ (time of the last activity) is 65534 clock ticks and the current time is 5, that is, the current time wrapped back around to 0 after clock tick 65536 was reached. The subtraction T_{c}−Tₐ is performed as an unsigned arithmetic operation such that 5−65534=7, that is there have been 7 clock ticks since the last activity, which is correct even though the clock wrapped back around to 0. This unsigned arithmetic operation will always yield the correct number of clock ticks since the last activity, as long as the clock does not wrap around to 0 and continue incrementing beyond the time of the last activity. For example, if the last activity occurred at 65534 as above, the current clock wrapped back to 0 after clock tick 65536 and then continued until reaching tick 65535, at which time the unsigned subtraction was performed, the result would be: T_{c}−Tₐ=65535−65534=1. This result is incorrect. Thus care must be taken to ensure the clock does not wrap around and pass the time of the last activity. In one embodiment where 32-bit numbers are utilized to measure the clock ticks (in lieu of the 16 bit numbers discussed above) the difference between two unsigned 32-bit numbers (the current time and the time of the last activity) will be correct so long as the current time T_{c} (typically the larger number) does not wrap around and exceed the time since the last activity Tₐ (typically the smaller number). For clock ticks or cycles of one millisecond, this problem occurs only if there is no counter reset in approximately 49.7 days.

Once the time since the last activity has been determined, as above, this value is subtracted from the timer's time-out value to yield the time interval until the next time out, assuming no reset activity. If this time interval is less than the range of the current bin, the timer is moved to the appropriate lower bin. If there has been activity and the timer has therefor been reset, the result of this subtraction can yield a value greater than the maximum time range of the current bin. The timer is therefore moved to the appropriate higher bin.

Each bin (except the bin 150) is checked at a frequency ensuring that none of the timers within the bin can have timed out since the last check. The rate at which the bin 150 is checked establishes the granularity of the time out process, i.e., the identification of timed-out timers. Any timer that times out can only be detected within the check interval set for the bin 150, which is one second in the FIG. 2 example.

As an example, assume a timer has a time-out value of 200 seconds. The timer is assigned to the bin 154 and the time at which the last activity occurred is set equal to the current time. Assume from this point that there is no activity and therefore the timer is not reset. All timers within bin 154 are checked within 100 seconds. It is not necessary, however, for all the timers to be checked in immediate succession. That is, a first group of timers in the bin 154 can be checked at 40 seconds and the remainder checked 60 seconds later, without danger of missing an expired timer. Assume that the timer of interest is checked 50 seconds after it was placed within the bin 154. Now the time to time-out is calculated as 150 seconds (200−50=150). Thus the timer is still within the bin 154 range. The timer is checked again 100 seconds later. At this time, assuming no reset activity, the time remaining until time-out is 50 seconds. This value falls within the range of the bin 152 and therefore the timer is moved to the bin 152. All timers in the bin 152 are checked at least every 10 seconds. Assume that the timer is checked 8 seconds after moving to the bin 152. Since the timer can now time out within 42 seconds (50−8=42) it remains in the bin 152. When it is checked three additional times within the bin 152, the timer will have time-out values of 32, 22, and 12 seconds. After each of these checks, the timer remains in the bin 152. Ten seconds later, the timer is checked again and found to have a time-out value of two seconds. Therefore, the timer is moved to the bin 150. Now the first timer check in the bin 150 must occur within one second. Assume that the check occurs 0.5 seconds later. The time-out value for the timer is now 1.5 seconds. The timer is checked again in one second and the timer out value is 0.5 seconds. At the next check, the timer has timed out. In fact, the time-out occurred 0.5 seconds prior to the timer check. Whatever action is associated with the timed-out timer is now initiated and the timer is released or closed. Note that the determination that a timer has timed out will never occur later than the check interval for the bin 150. That is, a timer in the bin 150 may have timed out at most one second before it is recognized.

In the example set forth above, the timer was checked ten times and was released within 0.5 seconds of its time out. This process according to the present invention represents a significant improvement over the prior art, according to which the timer would have been checked 200 times with the same release time accuracy. The worst care scenario for a timer in the bin 154, assuming no timer resets, would require 28 checks as the timer progresses through the bins 152 and 150 before timing out.

Continuing the example above, assume that the timer was reset to its initial value of 200 seconds, two seconds prior to the 12 second check in the bin 152. Now when the check is made, the time-out value is 198 seconds (200−2=198). This value corresponds to the range of the bin 154 and therefore the timer moves back to the bin 154, where it will be checked within 100 seconds.

Advantageously, according to the teachings of the present the computational load required to process the timers in a bin can be spread out over a time interval. It is not required that every timer in a bin be checked at the same time. It is only required that every timer in the bin be checked within the minimum bin range value. In the event there are a significant number of timers in a bin, a first number thereof can be checked at a first time and the bin labeled for checking again as soon as possible, but in any case within the bin check interval. During the second check process, it is necessary to check only those timers not evaluated during the earlier check.

In one embodiment, a certain order of the timers within the bin is maintained as new timers are always placed at the end of the bin list. In this way, a timer always has the same number or fewer timers ahead of it in the bin list, and the timer is always checked at the same relative time (or earlier as timers drop out of the bin) when the bin is processed. The only requirement for a multiple bin checking arrangement is that the number of timers checked during each checking interval must be great enough so that all timers in the bin can be checked before expiration of the bin processing time. As explained above, all the timers in the bin 150 are checked at the lowest granular time interval. Typically, this would be one clock tick in a microprocessor-based system. In the example of FIG. 2 the interval is one second. The number of timers in the bin 150 should remain relatively small since this bin has the smallest range and timers within it are close to timing out and being removed from the bin.

Table 1 below is a comparison of the number of time-out checks executed for a timer according to the prior art and according to the teachings of the present invention.

NUMBER OF CHECKS MADE

| INITIAL | | PRESENT INVENTION |
|---|---|---|
| TIME-OUT VALUE | PRIOR ART | (WORST CASE) |
| 1,000,000 | 1,000,000 | 1027 |
| 100,000 | 100,000 | 127 |
| 33,333 | 33,333 | 61 |
| 10,000 | 10,000 | 37 |
| 5,000 | 5,000 | 32 |
| 2,000 | 2,000 | 29 |
| 1,234 | 1,234 | 29 |
| 1,000 | 1,000 | 28 |
| 100 | 100 | 19 |
| 20 | 20 | 11 |
| 10 | 10 | 10 |
| 5 | 5 | 5 |

The table was constructed assuming that none of the timers are reset. In both cases, the numbers represent the total number of checks made before a time out is determined. The values set forth for the present invention are also worst case numbers since the actual value depends on the timing of the checking process relative to the time when the timer was assigned to the bin.

Note that the number of checks for those timers with an initial time-out value of 1,234 seconds is the same as that with an initial value of 2,000 seconds. This is true for all values between 1,001 and 2,000. It occurs because, in the worst case situation, the initial value check of this range of timeouts may be at the same time.

Although the present invention provides a more computationally efficient process for monitoring each one of a plurality of timers, the complexity of the actual steps involved in a single timer check are approximately equivalent in both the prior art and the current method. In the prior art, a check consists of a decrement step and a compare to zero step. According to the teachings of the present invention, a check comprises a subtraction and a comparison. Although the present invention requires fewer checks, the resolution of the time-out detection is the same in both the present invention and the prior art and is independent of the initial time-out values of the timers. The resolution is adjustable and depends only on the frequency at which bin 150 is checked.

FIG. 3 illustrates a flowchart for executing the timer monitoring process according to the present invention. The process begins at a step 190 when it is time to check a selected item or timer within a bin. At a step 192 the time remaining until time out is calculated according to the equation.

Tₒ−(T_{c}31 Tₐ)

That is, the difference between the time since the last reset activity (Tₐ) and the current time (T_{c}) is subtracted from the time-out value (Tₒ) of the selected timer. Thus this calculation requires storing only two time values, the timer's time-out value and the time since the last reset activity of the object associated with the timer. In another embodiment, in lieu of performing this calculation, the timer is decremented according to a specified clock cycle from its initial value to zero. Then the time remaining until time-out is determined by comparing the current timer value with zero. If there is a match, i.e., the current timer value is zero, then the timer has timed out. Whenever a reset action occurs, the timer is reset to its initial value.

In either case, the process proceeds to a decision step 194 for determining whether the time remaining until a time-out is less than or equal to zero. If the decision step 194 returns an affirmative result, a time-out is declared (see a step 196) and the timer is removed from the bin at a step 198. The process then ends for the selected timer at a step 200.

If the result from the decision step 194 is negative, the process continues to a decision step 202 to determine whether the calculated value T is less than or equal to the minimum or lower range value of the current bin. If it is, then the timer must be moved down one bin, as shown at a step 204. If the result of the decision step 202 is negative, the process continues to a decision step 206 to check if the time remaining until time-out is greater than the maximum value of the current bin. If the response is positive, then the timer is moved up one bin as shown at a step 208. If the response is negative than the process concludes at the step 200.

White the invention has been described with reference to the preferred embodiments, it will be understood by those skilled in the art that various changes may be made and equivalent elements may be substituted for elements of the invention without departing from the essential scope thereof. In addition, modifications may be made to adapt a particular situation to the teachings of the present invention without departing from the scope thereof. Therefore, it is intended that the invention not be limited to the particular embodiment disclosed as the best mode contemplated for carrying out this invention, but that the invention will include all embodiments falling within the scope of the appended claims.

What is claimed is

1. A method for controlling a plurality of timers, wherein each timer has an initial value and a time-out value and is associated with a like plurality of objects, said method comprising the steps of:
(a) forming a plurality of timer bins, wherein each timer bin has a predetermined time range defined by a maximum time and a minimum time;
(b) assigning each timer to the timer bin having a time range encompassing the initial value of the timer;
(c) setting each timer to the initial value of the timer;
(d) decrementing each timer at a predetermined interval;
(e) if a predetermined event occurs relative to an object associated with the timer, resetting the timer to the initial value of the timer;
(f) for each timer in each one of the plurality of timer bins and at an interval less than the maximum time associated with the timer bin, determining if the time remaining value of the timer is within the time range of the assigned bin; and
(g) moving the timer to the timer bin having a time range encompassing the time remaining value, if required.

2. The method of claim 1 wherein the step of decrementing further comprises decrementing each one of the plurality of timers until the timer value is zero.

3. The method of claim 1 wherein the time-out value for each timer is zero.

4. The method of claim 1 wherein each timer of the plurality of timers is decremented at the same predetermined interval.

5. The method of claim 1 wherein each object of the plurality of objects is a service flow of a cable modem system.

6. The method of claim 1 wherein the step (f) is executed at an interval equal to the minimum time of each timer bin.

7. The method of claim 1 wherein the time ranges of the plurality of timer bins comprise a plurality of contiguous time intervals, wherein the time range of the lowest timer bin extends from zero to a first predetermined value, and wherein the time range of the highest timer bin extends beyond a second predetermined value.

8. The method of claim 7 wherein the timers assigned to the lowest timer bin are checked more frequently than the timers in the remaining timer bins of the plurality of timer bins.

9. The method of claim 7 wherein the timers assigned to the lowest timer bin are checked at a rate that determines the granularity of the identification of timed-out timers.

10. The method of claim 1 wherein the step (g) further comprises: reassigning the timer to a timer bin having a higher time range or to a timer bin having a lower time range.

11. A method for controlling a plurality of timers, wherein each timer has an initial value and a time-out value and is associated with a like plurality of objects, said method comprising the steps of:
(a) forming a plurality of timer bins, wherein each timer bin is defined by a predetermined time range having a maximum time and a minimum time;
(b) assigning each timer to the timer bin having a time range encompassing the initial value of the timer;
(c) if a predetermined event occurs relative to an object, resetting the timer associated with the object to the initial value of the timer;
(d) determining the time remaining until each timer in each one of the plurality of bins times out, according to the formula:
Tₒ−(T_{c}−Tₐ),
wherein Tₒ is the time-out value of the timer, T_{c} is the current time and Tₐ is the time of the last timer reset;
(e) for each timer in each one of the plurality of timer bins and at an interval less than the maximum time associated with the timer bin, determining if the time remaining is within the time range of the assigned bin; and
(f) if required, moving the timer to the timer bin having a time range encompassing the time remaining value.
